(19) United States
(12) Patent Application Publication
(10) Pub. No.: US 2002/0062263 A1
(43) Pub. Date: May 23, 2002

(54) Method of providing store information and store information server

(75) Inventor: Akihiko Katou, Tokyo (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: NEC INFRONTIA CORPORATION

(21) Appl. No.: 09/988,280

(22) Filed: Nov. 19, 2001

(30) Foreign Application Priority Data
Nov. 20, 2000 (JP) 353420/2000

(51) Int. Cl. G06F 17/60; G06F 17/30; H04M 11/00

(52) U.S. Cl. 705/26; 705/28; 705/27; 707/10; 379/93.12

(57) ABSTRACT

A mobile-telephone terminal displays a commodity-selection menu for selecting a desired commodity, and sends commodity information regarding the selected commodity to a store-information server connected to a mobile-telephone network. A controller of the store-information server having received the commodity information searches a store-information database storing the commodity information and positional information representing a position of a store dealing the selected commodity, based on the commodity information and the positional information representing a position of the mobile-telephone terminal, and determines one store which is located closest to the mobile-telephone terminal and deals the selected commodity. The controller accesses a store terminal managing stock information representing the stock of the closest store, acquires the stock information of the selected commodity, and sends the acquired stock information together with information regarding the closest store to the mobile-telephoned terminal which will then display the store-information with the acquired stock information

### BACKGROUND OF THE INVENTION

1. Field of the Invention

The present invention relates to a method of providing information regarding stores (including shops, markets, etc.) and store information server, employing mobile telephones and the Internet and the like.

2. Description of the Related Art

A store-information service is one of information retrieval services for retrieving information using mobile phones, such as cellular phones, PHS (Personal Handyphone System), or the like. In this service, a user selects one desired commodity item from a plurality of commodity items displayed on a display screen of his/her mobile phone. Upon this, map information and text information including the name, address and phone number of a store which is located closest to the position of the user and deals the selected commodity, arc provided to the mobile phone of the user.

The information to be provided by the above information retrieval service does not include stock information indicating whether there is a stock of the selected commodity in the store specified in the provided-information. Thus; even if the user actually visits the store, there may be no stock or the selected commodity.

Further, tie above information retrieval service does not include means for giving an order (or advance order) for a commodity. Thus, the user can not directly give an order for a commodity through his/her mobile phone in this service, Therefore, to get the desired commodity, the user needs to call the store specified in the provided information and give an advance-order for the item, or the user needs to visit the store to purchase the commodity at the store.

Unexamined Japanese Patent Application KOKAI Publication No. H10-63749 discloses a commodity information providing method, wherein a database of commodity information is retrieved using an apparatus, such as a personal computer, a TV set, etc. through a communication line and the retrieved information is provided to users According to this method, the database is managed and operated by a service provider. Hence, the users need to pay the provider connection fee in addition to the telephone fee, when using the above service.

As explained above, according to the method disclosed in Unexamined Japanese Patent Application KOKAL Publication No H10-63749, the stock information is not provided. Thus, even if the user visits a store to purchase the desired commodity, the user may not able to get the commodity at the store. The disclosed method has a step of checking whether the desired commodity can be purchased by mail order and another step of checking whether the user wishes to purchase the desired commodity by mail-order However, the method does not have a step of giving a direct order for the desired commodity, so that the user can hardly purchase the desired commodity immediately after receiving of the information through the mobile phone.

### SUMMARY OF THE INVENTION

The present invention has been made in consideration of the above. It is accordingly an object of the present invention to provide a method of providing store information and a store information server, which are useful to users.

Another object thereof is to provide a method of providing store information and a store information server useful to users, providing users with store information including information representing whether there is a stock of the desired commodity and enabling to give an order for the commodity.

Still another object thereof is to provide a method of providing store information and a store information server, which are easy, effective and a low charge to use for users.

In order to achieve the above objects, according to the first aspect of the present invention, there is provided a method of providing a mobile-telephone terminal with store-information, said method comprising:

setting said mobile-telephone terminal to display a commodity selection menu, on which a user of said mobile-telephone terminal select a commodity from a plurality of commodities;

receiving commodity information regarding the commodity selected by the user;

searching a store-information database storing the commodity information and store summary information including a name, address and phone number of one or more stores dealing the commodity specified in the commodity information, based on the commodity information and positional information representing a position of the mobile-telephone terminal and determining one store located closest to the position of the mobile-telephone terminal among any other stores dealing the specified commodity;

accessing stock information representing a stock of commodities dealt by thee determined store, and acquiring the stock information; and

sending the store summary information regarding the determined store which is located closest to the position of the mobile-telephone terminal and the acquired stock information to the mobile-telephone terminal, and setting the mobile-telephone terminal to display the sent information.

According to this method, the store-information representing the closest store dealing the selected commodity is given to the user, together with the stock information of the commodity, upon selection of the commodity. Hence, the user can get necessary information regarding the selected commodity in accordance with easy operations of the mobile-telephone terminal.

The positional information may be obtained by a mobile-telephone base station to which said mobile-telephone terminal is connected.

The method may further including;

in a case where to specify the positional information,

receiving identification information for identifying a mobile-telephone base station to which said mobile-telephone terminal is connected; and

specifying the positional information, based on the identification information

The method way flintier include:

in a case where to specify the positional information,

receiving intensity information representing intensity of waves to be received from one or more neighboring mobile-telephone base stations to said mobile-telephone terminal and base-station identification information of the one or more neighboring mobile-telephone base stations; and

specifying the positional information, based on the intensity information and the base-station identification information

The method may further include

in a case where to specify the positional information,

accessing a position-information server, providing the positional information of die mobile telephone terminal bused on intensity information representing intensity of waves be received from one or more neighboring mobile-telephone base stations to said mobile-telephone terminal and base-station identification information of the one or more neighboring mobile-telephone base stations, thereby specifying the positional information

The positional information may be obtained by said mobile-telephone terminal performing data communication with a GPS (Global Positioning System) satellite.

The method may further include

in a case where to acquire the stock information,

accessing a store terminal managing the stock information,

The stock information may be updated in real time by said store terminal.

The method may further include:

setting said mobile-telephone terminal to display a commodity-ordering page for making an order for the selected commodity;

receiving commodity-ordering information which said user input to give the order for selected commodity on e commodity-ordering page;

sending e received commodity-ordering information to a store terminal managing the stock information; and

sending advance-ordering information representing an advance order for the ordered commodity to said mobile-telephone terminal, in response it a reply to the commodity-ordering information from the store terminal.

Accordingly, the user can give an order for a desired commodity through easy operations of the mobile-telephone terminal, without visiting the store dealing the desired commodity.

Furthermore, the user can uses the store-information service without a connection to an Internet Service Provider, the user will owe few fees.

In order to achieve the above objects, according to the second aspect of the present invention, there is provided a method of providing a mobile-telephone terminal with store-information, said method comprising;

setting said mobile-telephone terminal to display a commodity selection menu for selecting one commodity from a plurality of commodities, on said mobile-telephone terminal;

sending commodity information regarding the commodity selected by a user of said mobile-telephone terminal on the commodity selection menu, to a store-information serve connected to a mobile-telephone network;

searching a store-information database storing the commodity information and store summary information including a name, an address and a phone number of one or more store dealing the commodity specified in the commodity information, bused on the commodity information and positional information representing a position of the mobile-telephone terminal, in said store-information server having received the commodity information, and determining one store located closest to the position of the mobile-telephone terminal among any other stores dealing the commodity specified in the commodity information, on said store-information server having received the commodity information;

accessing stock information representing a stock of commodities dealt by the determined store, and acquiring, the stock information; and

sending the store summary information regarding the determined store which is located closest to the position of the mobile-telephone terminal and the acquired stock information to the mobile-telephone terminal, and setting the mobile-telephone terminal to display the sent information.

In order to achieve the above objects, according to the third aspect of the present invention, there is provided a store-information server coupled to a mobile-telephone network through a communication line and comprising a processor; a storage unit, an input/output unit performing data communications with said mobile-telephone network through the communication line, a communication unit coupled to a store-terminal managing stock information of commodities dealt by each of a plurality of stores, through a network; and a store-information database storing commodity information regarding each or the commodities and store summary information including a name, an address and a phone number of each of the stores dealing the commodity specified in the commodity information,

wherein said processor

receives the commodity information regarding a commodity selected by a user of said mobile-telephone terminal, from said mobile-telephone terminal through said input/output unit,

searches said store-information database for one store located closest to a position of said mobile-telephone terminal among any other stores dealing the user-selected specified commodity, based on the commodity information regarding the user-selected commodity and positional information representing the position of said mobile-telephone terminal,

accesses a store terminal managing stock information of the determined store closest to the position of said mobile-telephone terminal, and acquires the stock information of the selected commodity, and

sends the store summary information regarding the determined store closest to the position of said mobile-telephone terminal and the acquired stock information to said mobile-telephone terminal, and sets said mobile-telephone terminal to display the Sent information thereon.

In order to achieve the above objects, according to the fourth aspect of the present invention, there is provided a program for controlling a computer to execute:

setting a mobile-telephone terminal to display a commodity selection menu for selecting a commodity from a plurality of commodities;

receiving commodity information regarding the commodity selected by a user of said mobile-telephones terminal on said commodity selection menu;

searching a store-information database storing the commodity information and store summary information including a name, an address and a phone number of a sty dealing the commodity specified in the commodity information, based on the commodity information and positional information representing a position of the mobile-telephone terminal, and determining one store located closest to the position of the mobile-telephone terminal among any other stores dealing the commodity specified in the commodity information;

accessing stock information representing a stock of commodities dealt by the determined closest store, and acquiring the stock information; and

sending the store summary information regarding the determined store which is located closest to the position of the mobile-telephone terminal and the acquired stock information to the mobile-telephone terminal, and setting the mobile-telephone terminal to display the sent information

### BRIEF DESCRIPTION OF THE DRAWINGS

These objects and other objects and advantages of the present invention will become more apparent upon reading of the following detailed description and the accompanying drawings in which:

FIG. 1 is a block diagram showing the entire structure of a system according to the first embodiment of the present invention;

FIGS. 2A and 21 are flowcharts each showing operations of the system of the first embodiment;

FIG. 3 is a diagram showing an example of a commodity guidance page provided by the system of the first embodiment;

FIG. 4 is a diagram showing an example of a commodity search page provided by the system of the first embodiment,

FIG. 5 is a diagram showing an example of a search result page provided by the system of the first embodiment;

FIG. 6 is a block diagram showing the entire structure of a system according to the second embodiment of the present invention;

FIGS. 7A, 7B and 7C are flowcharts each showing operations of the system of the second embodiment;

FIG. 8 is a diagram showing an example of a search result page provided by the system of the second embodiment;

FIG. 9 is a diagram showing an example of a commodity ordering page provided by the system or the second embodiment; and

FIG. 10 is a diagram showing an example of an advance-order reception page provided by the system or the second embodiment

### DETAILED DESCRIPTION OF THE PREFERRED EMBODIMENTS

Preferred embodiments of the present invention will now be explained with reference to the accompanying drawings.

A system according to the first embodiment of the present invention will now be described

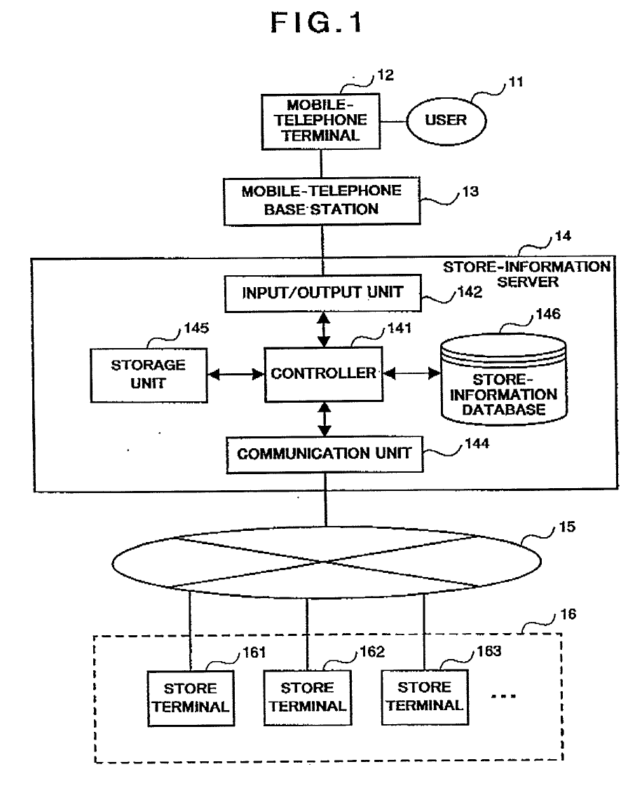

FIG. 1 is a block diagram showing the entire structure of the system according to the first embodiment of the present invention. This system comprises one or more mobile telephone terminals 12, one or more mobile telephone base stations 13, a store-information server 14 mad a plurality of store terminals 16, as shown in FIG. 1.

Each mobile telephone terminal 12 is a cellular phone or a PHS (Personal Handyphone System), and can communicate with one mobile telephone base station hereinafter referred to as base station) 13 through radio communication. The mobile telephone terminal 12 has a display function to display a commodity guidance page in relation to services for providing commodity information to be sent from the base station 13. The mobile telephone terminal 12 appropriately switches the commodity guidance page to another page in accordance with button operations of a user 11 The mobile telephone terminal 12 displays an information item corresponding to a commodity item requested by the user 11, so t the user 11 can select the information item displayed on the mobile telephone terminal 12 The mobile telephone terminal 12 send, the user-selected information item to the base station 13, as commodity information.

The mobile telephone terminal 12 displays store information sent from the base station 13. The store information represents the nearest store from the mobile telephone terminal 12, for example, text information showing the name of the nearest store from the mobile telephone terminal 12, address of the store, phone number of the store, etc. Further, the mobile telephone terminal 12 displays a commodity ordering page sent from the base station 13, and sends information representing the contents of the ordering to the base station 13.

The base station 13 can communicate with the mobile telephone terminal 12 through radio communication, and is connected to the store information server 14 through a private line.

When receiving, commodity information sent from the mobile telephone terminal 12, the base station 13 identifies the place from which the mobile telephone terminal 12 sends the commodity information. Then, the base station 13 compares the identified place with a position table, thereby to create position data It is preferred that the position data specify the latitude, longitude, and/or city name of the identified place. The base station 13 sends the received commodity information and created position data to the store information server 14. The base station 13 receives the store-information which is searched based on the commodity information and position data, and sends the received store-information to the mobile-telephone terminal 12

As described above, the store information server 14 is connected to the base station 13 through the private line, and can access the store terminal 16 through the Internet 15. Any store having the store terminal 16 is registered in a store information database 146, as will be described later.

The store information server 14 comprises a controller 141, an input/output unit 142, a communications unit 144, a storage unit 145 and a store information database 146.

The controller 141 includes a processor, etc., and receives the position data and commodity information sent from the mobile telephone base station 13 through the input(output unit 142. The controller 141 searches the store information database 146 based on the received position data and commodity information, and extracts e store information regarding the nearest store (closest store to the mobile telephone terminal 12) dealing the commodity item desired by the user 11.

The controller 141 temporarily stores The store summary information and commodity information of the neatest store in the storage unit 145. The store summary information includes a store name, an address and a phone number of each store, and so forth.

The controller 141 accesses a store terminal 161 of the nearest store through the communications unit 144. The controller 141 searches for the latest stock information of the store terminal 161, based on the commodity information stored in the storage unit 145. The controller 141 stores the searched stock information in the store unit 145.

The controller 141 sends the store summary information of the nearest store and the stock information, which are stored in the storage unit 145 to the mobile telephone base station 13 through the input/output unit 142.

The input/output unit 142 is connected to the base station 13 through the private line. The input/output unit 142 controls the input and output toward the private line, and sends information provided from the controller 141 to the base station 13 through the private line. Then, the input/output unit 142 provides the controller 141 with information, sent from the base station 13 through the private line. For example, the input/output unit 142 receives the position information and the commodity information sent from the base station 13, provides the received position information and commodity information to e controller 141, and sends the store summary information of the nearest store and the stock information to the base station 13

The communications unit 144 can be connected to a plurality of store terminals 16 through the Internet 15 The communication wait 144 controls data communications in relation to the Internet, provides the controller 141 with information received from the Internet 15, and sends the information provided from the controller 141 toward the Internet 15. Upon reception of access information corresponding to the store terminal 161 of the nearest store from the controller 141, the communications unit 144 sends the received access information toward the Internet 15 and connects to the store terminal 161.

Note that the access information includes a URL (Uniform Resource Locator), an IP address, an identifier, a password, etc.

The storage unit 145 stores the store summary information of tie nearest store and the commodity information that are received by the controller 141. The storage unit 145 stores stock information of the nearest store in association with a corresponding commodity items where the stock information is searched by the controller 141.

The storage unit 145 stores the access information stored in the store information database 146 and necessary for accessing the plurality of store terminals 16 of a plurality of stores, as data corresponding to each of the plurality of store terminals 16.

The store information database 146 is provided for the predetermined area for example, the area managed by a control center that controls a plurality of base stations. The store information database 146 stores store summary information and commodity information regarding any of those commodities dealt by the plurality of stores. As described above, the store summary information include a store name, an address and a phone number of each store, and go forth.

The controller 141 searches the store information database 146 for stored information, based on the position data and commodity information as search conditions. The controller 141 reads out the store summary information of the nearest store dealing a corresponding commodity item and also commodity information regarding the item.

The store terminal 16 is connected to the store information server 14 through the Internet 15. The store terminal 16 updates in real time the stock information of any items dealt at the corresponding store, in conjunction with a POS (Point Of Sales) system In response to predetermined access information sent from the store information server 14, the store terminal 16 retrieves stock information of a corresponding commodity based on the received commodity data, and outputs the retrieved stock information to the store information server 14.

Explanations will now be made to operations of the system according to the first embodiment of present invention, while providing store information.

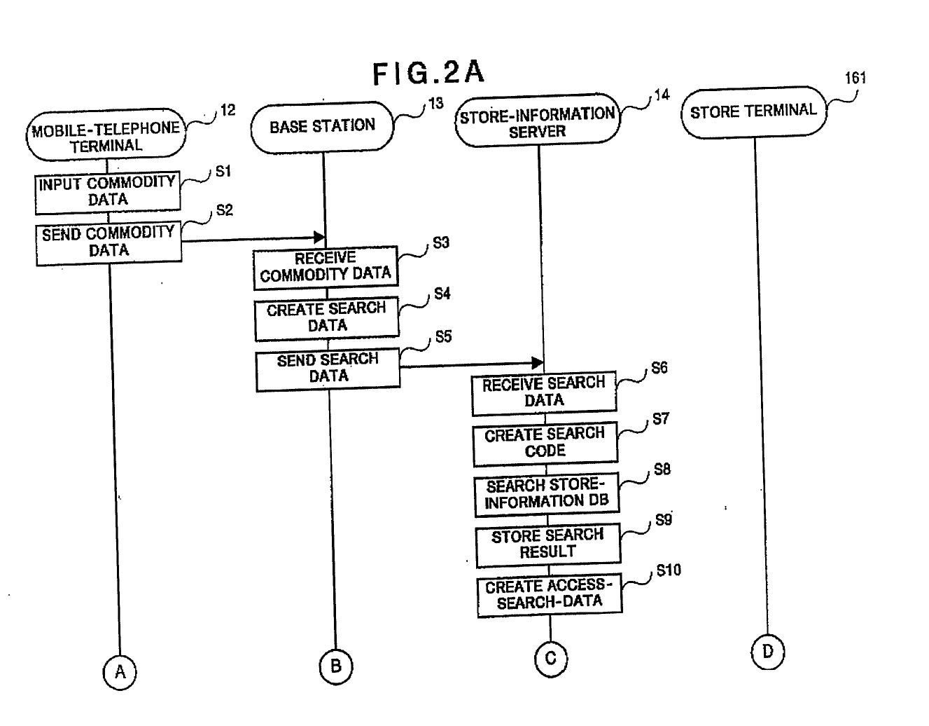

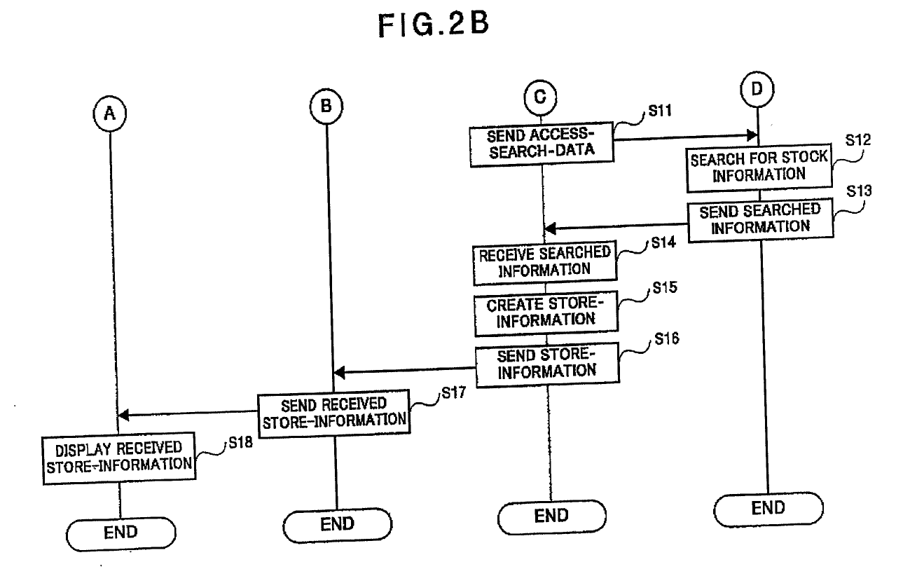

FIGS. 2A and 2B are flowcharts each showing the flow of operational procedures and operations of the structural elements of the system

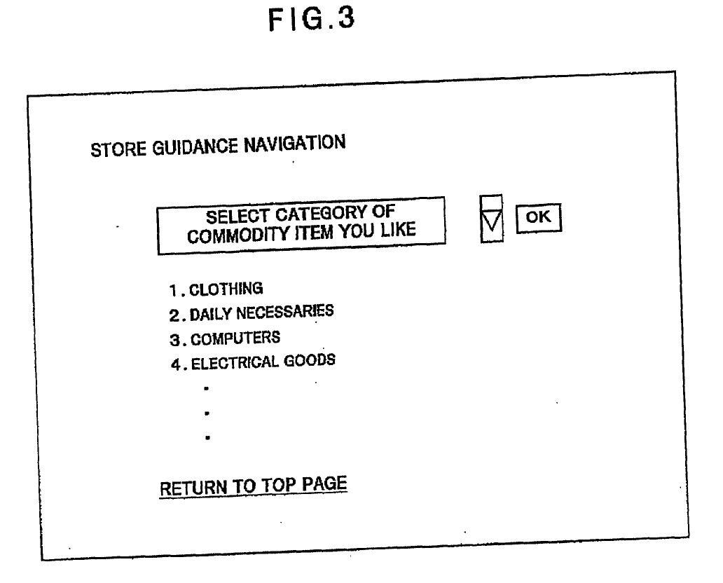

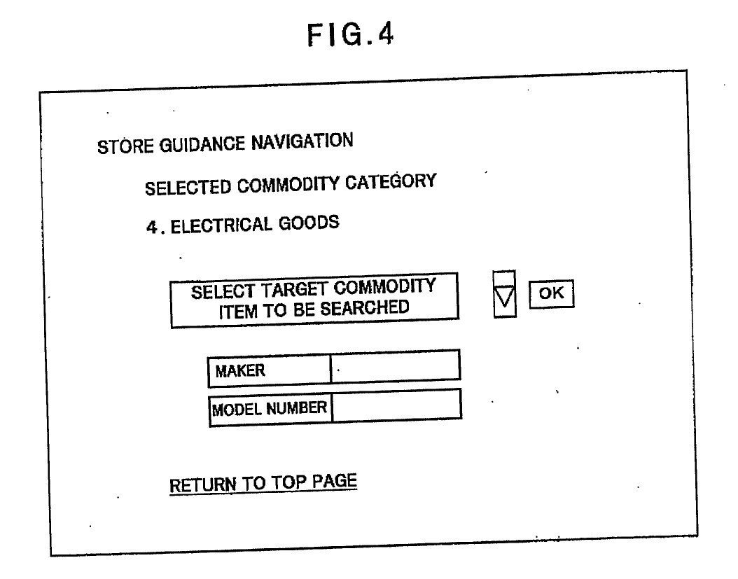

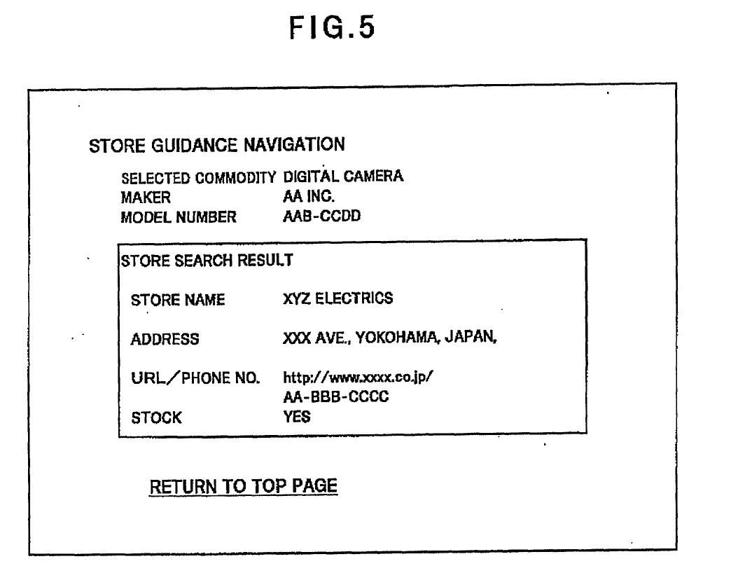

The mobile telephone terminal 12 displays a commodity guidance page shown in FIG. 3, in accordance with operations of the user 11. The mobile telephone terminal 12 displays a commodity search page shown in FIG. 4, right after the user 11 selects a category of commodity item to be searched on the commodity guidance page. The mobile telephone terminal 12 receives data representing the manufacturer (maker) or commodity number of the selected category of commodity item, as commodity data for identifying the item that the user wants to search for on the commodity search page (Step S1). 1he mobile telephone terminal 12 encodes the received commodity data and sends the encoded data to the base station 13, as the commodity data of the item to be searched (Step S2).

The base station 13 decodes the received commodity data, and sets the decoded data as the commodity data of the commodity item to be searched (Step S3) Further, when receiving the commodity data, the base station 13 detects the position of the mobile-telephone triennial 12 from which it sends information to the base station 13, and creates position data based on which the positional range of the corresponding store is determined using the detected position The base station 13 creates search data for searching for any stores dealing the requested item, together with the created position data and received commodity data (Step S4), and sends the data created in the step S4 to the store-information server 14 (Step S5),

The controller 141 of the store information server 14 receives the search data sent by the base station 13 through the input/output unit 142 (Step S6). The controller 141 transforms the commodity data position data included in the received search data into internal search expressions for searching the store information database 146, so as to create a search code (Step S7).

The controller 141 searches the store information database 146 for store information, based on the created search code (Step S8). The controller 141 selects the closest store dealing the category of commodity, reads out the store summary information of the closet store, and stores the store summary information in the storage unit 145 (Step S9). The controller 141 reads out access data for accessing the store terminal 161 of the closest store from the store information database 146. Based on a commodity code corresponding to the read access data and commodity data, the controller 141 creates access-search-data for requesting the store terminal 161 to search for the stock information of the commodity (Step S10).

The controller 141 send the created access-search-data to the store terminal 161 of the closest store through the communication unit 144, accesses the store terminal 161, and sends a request to the store terminal 161 for searching for the stock information of the commodity (Step S11).

The store terminal 161 of the closest store receives a request for searching for the stock of the commodity from the store information server 14, and searches for the stock information of the commodity item which is updated in real time, based on its commodity code (Step S12). The store terminal 161 sends the searched stock information to the store information server 14 through the Internet 15 (Step S13).

The controller 141 receives the stock information sent from the store terminal 161 through the communications unit 144, and stores the received stock information in the storage unit 145 (Step S14) The controller 141 reads out, from the storage unit 145, the store summary information of the closest store which is stored in the storage unit 145 in the step S9 and the stock information which is stored in the storage unit 145 in the step S14. Further, the controller 141 reads out Internet address information (e.g. URL address, etc.) from the access information of the closest store, which is stored in thief store-information database 146. Then, the controller 141 creates the store information, based on the store summary information, the stock information and the address information (Step S51).

The controller 141 sends the crated store information to the base station 13 through the input/output unit 142 (Step S16). The base station 13 encodes the received store-information into signal information for displaying the received store information on the mobile telephone terminal 12, and sends the encoded information to the mobile telephone terminal 12 (Step S17).

The mobile telephone terminal 12 decodes the received signal information, displays the name, address, phone number and Internet address information of the closest store, as store information data, and displays also stock information of specified commodity items(Step S18).

As explained above, according to the first embodiment, the user 11 can get the store summary information of the closest store dealing the specified commodity item and the latest stock information of he specified commodity item, upon easy operations of the mobile telephone terminal 12. Hence, the Internet connection fee is not particularly issued by the Internet Service Provider, ad the mobile telephone terminal 12 communicates with the base station 13 which is located closest to the mobile telephone terminal 12. Therefore, the telephone fee would be very low, and thus realizing a reasonable and convenient system for the user.

In the first embodiment, it has been explained that the store summary information, such as ;the address, etc. of the closest store is displayed in the form of text information. However, the base station 13 may mark the position Or the closest store on the map including loads, landmarks, etc. based on the latitude and longitude. Then, the base station 13 may display the marked position of the closest store on the page of the mobile telephone terminal 12.

In the first embodiment, the base station 13 compares the place from which the mobile telephone terminal 12 transmits information in the step S4, so as to create the position data. However, the mobile telephone terminal 12 may include a GPS (Global Positioning System), and may obtain data (as latitude and longitude information) specifying the its own position using the GPS. When to send the commodity information to the base station 13 in the step S2, the mobile telephone terminal 12 may send the obtained position data (the latitude and longitudinal information) together with the commodity information.

In the first embodiment, the store information server 14 searches the store information database 146 for the stored store summary information and commodity information. For example, the store information server 14 searches for the store summary information and commodity information using a condition of a predetermined distance area (e.g. a 500 m×500 m area), based on the received position data of the mobile telephone terminal 12. In the case where there is no corresponding store as a result of the searching, the searching can be done with a condition of a wider area

Further, the user 11 may select one target distance area to be searched from the mobile telephone terminal 12, for example, from areas of 5 km×5 m, 1 km×1 km, 500 m×500 m.

In the first embodiment, the store information server 14 searches the store information database 146 for the closest store, based on the position data and commodity data received from the base station 13, and accesses the store terminal 161 of the searched store. However, not simply the closest store, the store information server 14 may extract any stores within a predetermined distance area away from the position of the mobile telephone terminal 12, access the store terminals 161, 162 and 163 of the plurality of stores, and acquire the stock information of specified commodity items. In this case, the base station 13 may send the information representing the number of corresponding stores and names of the stores, their store summary information and commodity information, to the mobile telephone terminal 12.

In the first embodiment, the closes store is searched based on the position data or the mobile telephone terminal 12 which is created by the mobile telephone base station 13. However, in the base station communicable with the mobile-telephone terminal 12, the position of one base station from which the mobile telephone terminal receives the strongest radio communication waves among any other base station may be used as the position data.

A system according to the second embodiment of the present invention will now be described.

In the second embodiment, explanations will now be made to an example of a system that enables to take an order for commodity items, in addition to providing store information of the closest store and stock information of commodity items.

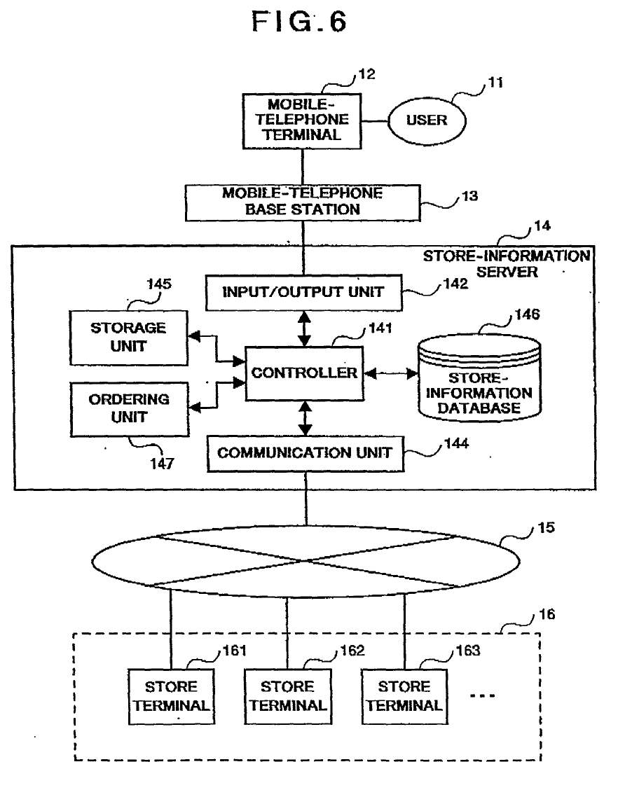

FIG. 6 is a block diagram showing the entire structure of the system according to the second embodiment of the present invention. The structure of this system is the same as the structure of the system a ring to the first embodiment, except that the store-information server 14 includes an ordering unit 147. The same structural elements as those of the first embodiment are denoted by the same reference numerals.

Each of the mobile telephone terminal 12, the base station 13 and the store terminal 16 has the same function and structure as that described in the first embodiment, and additionally include a function for taking an order (an advance-order) for a commodity item. Brief description will be made to each function for advance-ordering for commodity items.

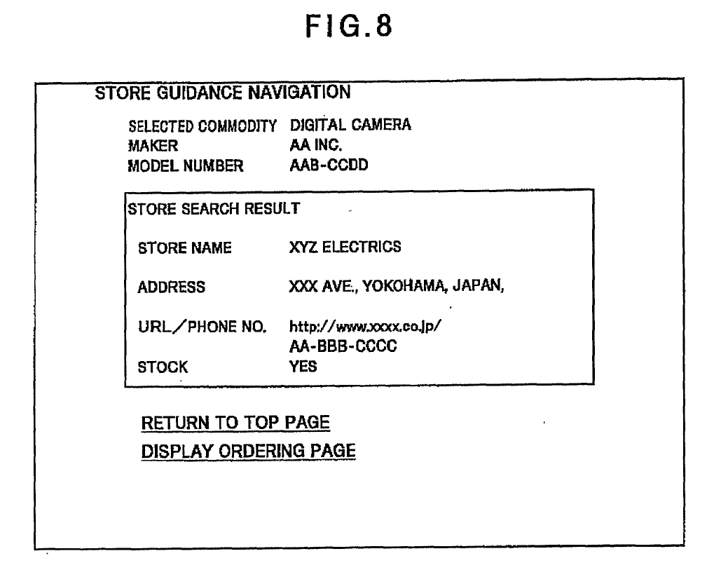

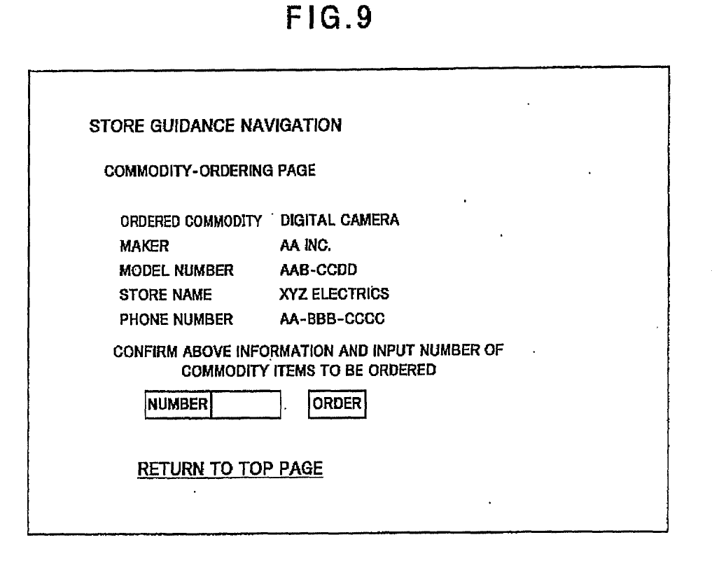

On a search-result page shown in FIG. 8 and sent from the mobile-telephone base station 13, once the user 11 clicks on “Display Ordering Page”, the mobile-telephone terminal 12 displays a “Commodity Ordering Page” shown in FIG. 9. On the “Commodity Ordering Page”, if the user inputs the number of commodity items to be ordered and clicks on “Order” button, alter reviewing the contents of the displayed page, the mobile-telephone terminal 12 sends the information displayed on the “Commodity Ordering Page” and the ordering information including the number input by the user 11 to the mobile-telephone base station 13.

The mobile-telephone base station 13 receives the ordering information sent from the mobile-telephone terminal 12, and sends the received ordering information to the store terminal 16 through the store-information server 14. Further, the mobile-telephone base station 13 receives advance-ordering information sent by the store terminal 16 in response to the ordering information, tough the store-information server 14, and sends the advance-ordering information to the mobile-telephone terminal 12.

In response to predetermined access information from the store-information server 14, the store terminal 16 is accessed by the store-information server 14, receives an advance-order for commodity items based on the received ordering information, and sends the received advance-ordering information to the store-information server 14

As shown in FIG. 6, the store-information server 14 includes the controller 141, the input/output unit 142, the communications unit 144, the store-information database 146, and the ordering unit 147.

The ordering unit 147 creates ordering information for making an advance-order for commodity items toward the store terminal 16, based on the ordering information that the controller 141 received from the mobile-telephone base station 13 through the input/output unit 142. The controller 141 sends the created ordering information together with the access information to the store terminal 16 through the Internet 15, and sends a request for giving an advance-order for a corresponding commodity item to the store terminal 16.

Operations of the system according to the second embodiment of the present invention, while providing store information, will now be explained.

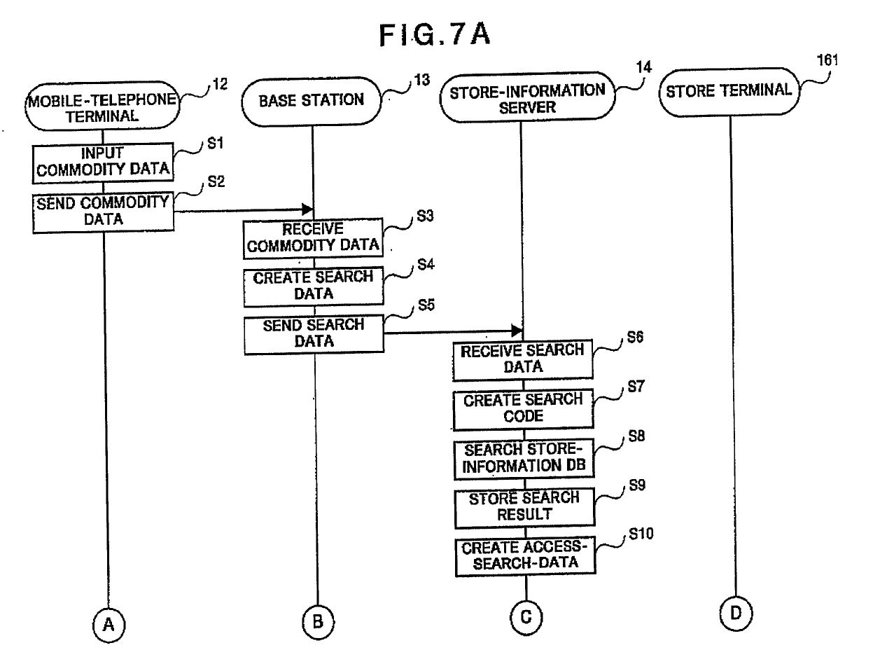

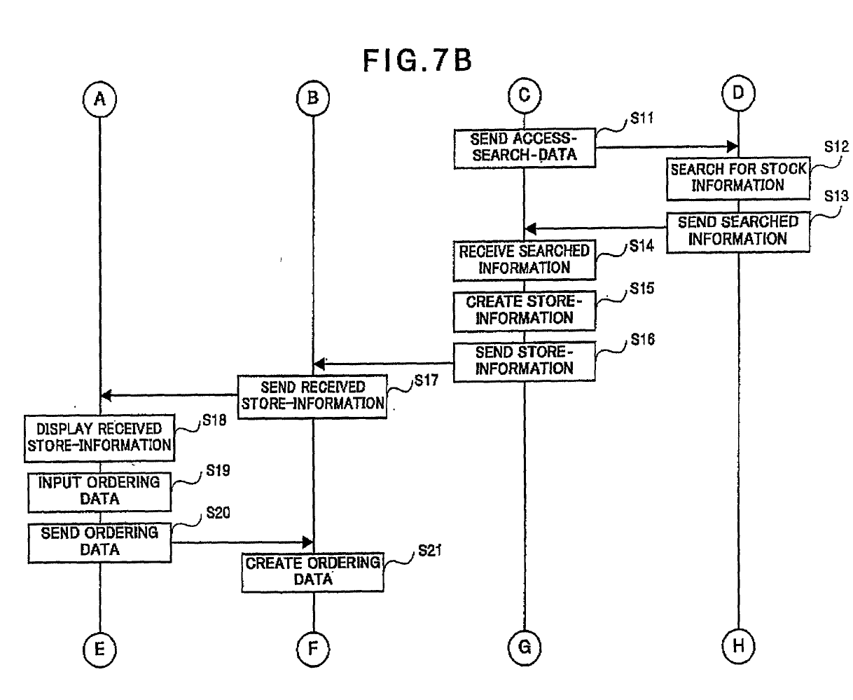

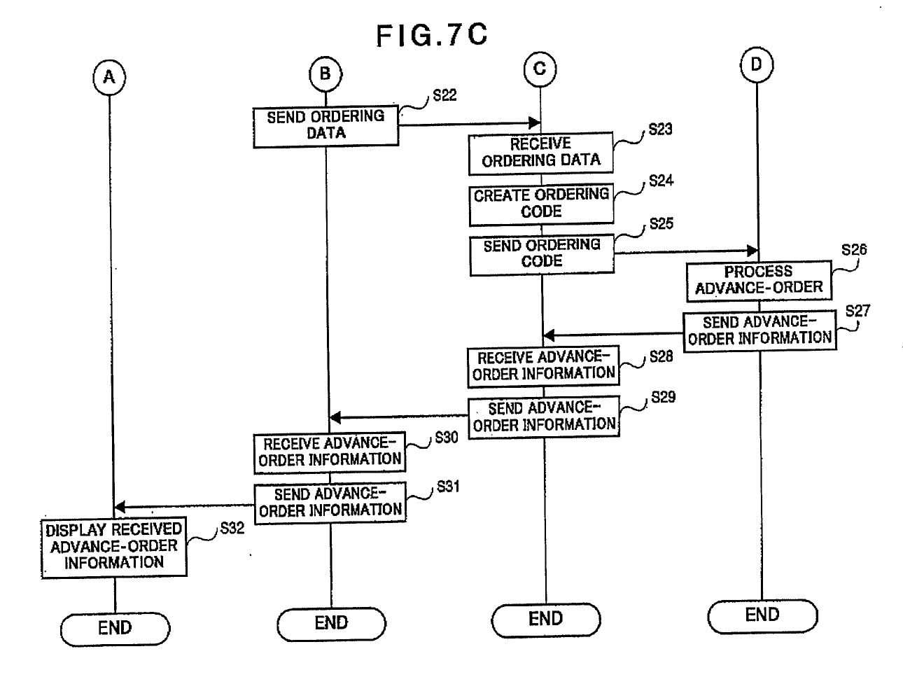

FIGS. 7A, 7B and 7C are flowcharts each showing the flow of operational procedures and operations of the structural elements

Of the procedures shown in FIGS. 7A, 7Y and 7C, the procedures in steps 1 to 17 are the same as those described in the first embodiment. In FIGS. 7A, 7B and 7C, the same reference numerals are attached to the data to be transmitted and those procedures up until the mobile-telephone base station 13 sends the tore information and stock information to the mobile-telephone terminal 12. Explanations will now be made to the procedures and operations of the system with reference to FIGS. 7A, 7B and 7C, in the case where an advance-order for commodity items are made after the step S17 described in the first embodiment, i.e. after the mobile-telephone terminal 12 displays the store summary information and stock information sent from the mobile-telephone base station 13.

The mobile-telephone terminal 12 displays the search-result page illustrated in FIG. 8 (Step S18). As illustrated in FIG. 8, displayed on the search-result page are store summary information and stock information or commodity items which are sent form the mobile-telephone base station 13. After checking the store summary information and stock information displayed on the mobile-telephone terminal 12, the user 11 selects to advance to a commodity-ordering page on the search-result page. On the commodity ordering page illustrated in FIG. 9 and displayed on the mobile-telephone terminal 12, the user 11 checks the commodity name, store name, etc., inputs the number of commodity items to be ordered, and settles the displayed and input ordering data thereon. Upon settlement of the displayed and input ordering data, the mobile-telephone ten 12 receives the ordering data (Step 519), encodes the input ordering data, and sends the encoded data to the mobile-telephone base station 13 (Step S20).

The mobile-telephone base station 13 decodes the received ordering data (Step S21). The mobile-telephone base station 13 sends the decoded ordering data to the store-information server 14 (Step S22).

The store-information server 14 receives the ordering data transmitted by the mobile-telephone base station 13 through the input/output unit 142 (Step S23). The controller 141 controls the ordering unit 147 to create a store code, a commodity code and an ordering code, to which an ordering number is attached and which includes the number of commodity items to be ordered, for ordering the commodity items from the store terminal 161 of the closest store, based on the received ordering data. The controller 141 creates access-ordering data for giving an order for a corresponding commodity item(s) from the store terminal 161, using the created ordering code and access information for accessing the store terminal 161 (Step S24).

The controller 141 sends the created access-ordering data to the store terminal 161 of the closest store through the communications unit 144, and sends a request for an advance-order for the corresponding commodity item thereto (Step S25).

The store terminal 161 of the closest store receives the request for the advance-order for the corresponding commodity item from the store-information server 14, and carries out a processing for making an advance-order for the commodity item based on the specified ordering code (Step S26). The store terminal 161 includes a message that the advance-order has been made in advance-order information, and sends the advance-order information to the store-information server 14 through the Internet 15 (Step S27).

The controller 141 receives the advance-order information sent from the Store-terminal 161 through the communication unit 144 (Step S28), and sends the received advance-order information to the mobile-telephone base station 13 through the input/output unit 142 (Step S29). The mobile-telephone base station 13 receives the advance-order information from the store-information server 14 (Step S30). After this, the mobile-telephone base station 13 encodes the received advance-order information into signal information for displaying the advance-order information on the mobile-telephone terminal 12, and sends the signal information to the mobile-telephone terminal 12 (Step S31)

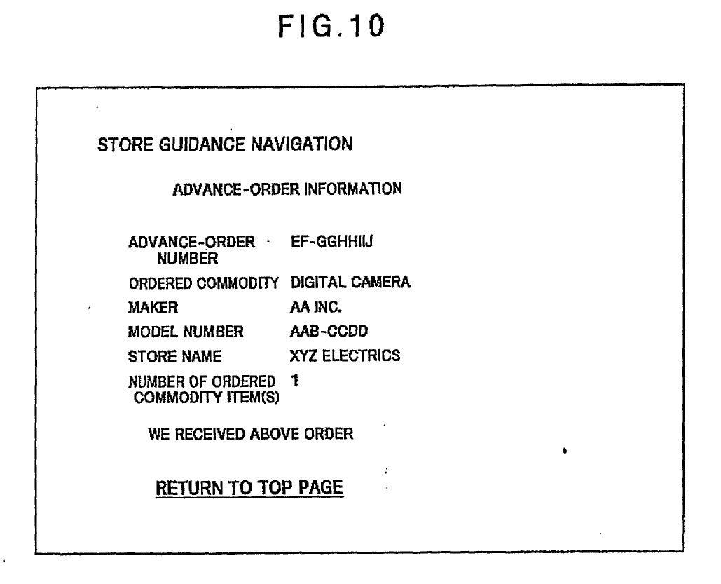

The mobile-telephone terminal 12 decodes the received signal information, and displays, on an advance-order reception page illustrated in FIG. 10, advance-order information of the commodity item, including an advance-order ID number, the store name, the commodity name and the message (Step S32).

As explained above, according to the second embodiment, the user 11 searches for the stock information and store summary information of the closest store dealing the desired commodity item, using the mobile-telephone terminal 12. If there is a stock of the desired commodity item, the user 11 can make an order for the commodity item in accordance with simple operations so as to succeed in macing an advance-order thereafter. In such circumstances, the user 11 just go to the store whenever he/she likes to gel the ordered commodity item, and hence realizing a convenient system for the users.

In the above-described second embodiment, the controller 141 may store, in the storage unit 145, the ordering code created by the ordering unit 147 and the advance-order information sent from the store terminal 161 of the closest store, based on the ordering information received from the mobile-telephone bile station 13. That is, to control the ordering information and advance-order information in association with each other, every time an order is made by the user, the controller 141 stores the order cod and advance-order information temporarily in the storage unit 145, for example After this, the controller 141 reads out the stored ordering code and advance-order information therefrom. Then, the controller 141 may store the read ordering code, advance-order information, ID) information of the user or mobile-telephone terminal 12 and date/time information of the ordering, in an advance-order database which is prepared separately from the store information database 146.

In the second embodiment, after the store summary information and stock information of the commodity item are sent to the mobile-telephone terminal 12, the user 11 is to make an advance-order for the commodity item. However, in the case where the user 11 has already known the store summary information and stock information, the user 11 may call the mobile-telephone terminal 12 to retrieve the commodity ordering page, for making an order for desired commodity items.

Various embodiments and changes may be made thereonto without departing from the broad spit and scope of the invention.

For example, in the above-described embodiments, the store-information server 14 is connected to the mobile-telephone base station 13 through a private line. However, the store-information server 14 may be connected to the mobile-telephone base station 13 using an arbitrary communications network, such as the Internet, a packet communications network, a radio communications network, mobile telephone network

In the above embodiments, there is prepared only one store-information server 14. However, a plurality of ;tore-information servers 14 may be installed for phone connection areas with predetermined size. In this structure, a plurality of base stations 13 and a plurality of store-information servers 14 may form a network, such as a WAN (Wide Area Network), etc. Otherwise, the store-information server 14 may be prepared for each type of commodity items.

In the above embodiments, the explanations have been made to a method of providing store-information using the mobile-telephone terminal 12. However, this method is applicable to a technique which employs any other information terminal, such as a fixed phone, a personal computer having a communications system, a PDA (Personal Digital Assistance), etc. In this case, to specify the position of the user, the user specifies his/her position information when starting to user the services for providing the store-information.

In the above embodiments, the store-information server 14 does not include any particular input/output means. However, the swore-information server 14 may have input/output means, such as a keyboard, printer, etc., as needed, so as to search for, correct, and/or print stored information for example.

In the above embodiments, a store-information service function included in the controller 141 of the store-information server 14 may be realized by a software program, and the controller 141 may execute this program. Similarly, in tile second embodiment, the functions or the ordering unit 147 may be realized by a software program, and the controller 141 may execute this program.

In the above embodiments, the mobile-telephone terminal 12 may be a general mobile-telephone terminal having a function for browsing the contents of Web pages on the Internet, instead of a terminal for particularly services for providing store-information or making orders for commodity items. That is, the mobile-telephone terminal 12 may be a mobile-telephone terminal including a browser for browsing the contents described in a contents description language, such as HTML (Hypertext Markup Language), etc.; a communication protocol for transmitting/receiving such contents; and operational means for connecting to the store-information server 14 through e mobile-telephone base station 13, etc. Similarly, the mobile-telephone base station 13 may be a general mobile-telephone base station forming a mobile-telephone network. In this case, the store-information server 14 describes the contents of various pages to, be displayed on the mobile-telephone terminal 12 in the above-described contents description language, and sends the described contents information to the mobile-telephone terminal 12. The mobile-telephone terminal 12 connects to the store-information server 14 through the mobile-telephone bas station 13, etc., in accordance with user operations. Then, the mobile-telephone terminal 12 receives the contents of various pages, such as Web pages which are written in the above-described contents description language, from the store-information server 14 through the mobile-telephone base station 13, etc. The mobile-telephone terminal 12 displays the received contents on its display. Further, the mobile-telephone terminal 12 sends information representing user operations on the display screen to the store-information sever 14 through the mobile-telephone base station 13, in accordance with the format of the contents description language. The mobile-telephone base station 13 transforms the information, sent from the mobile-telephone terminal 12 to the store-information sever 14 based on radio communication, into a format for performing data communications with the store-information server 14, and sends the transformed information to the store-information server 14. The mobile-telephone base station 13 transforms the information sent from the store-information server 14 to the mobile-telephone terminal 12, into a format for radio communication, and sends the transformed information to the mobile-telephone terminal 12 through radio communication.

In the above-described embodiments, the mobile-telephone base station 13 specifies the position of the mobile-telephone terminal 12. Instead, the store-information server 14 may specify an approximate position of the mobile-telephone terminal 12 based on the position of the mobile-telephone base station 13. Otherwise, the mobile-telephone terminal 12 sends, to the store-information server 14, information regarding the intensity of wave received from at least one neighboring mobile-telephone base station, together with information identifying the at least one mobile-telephone base station Upon reception of the above information from the mobile-telephone terminal 12, the store-information server 14 may specify the position of the mobile-telephone terminal 12 based on the received information. Further, a position-information server may be prepared separately from the store-information server. In this structure the mobile-telephone terminal 12 sends ID information of the at least one mobile-telephone base station and information regarding the wave intensity, to the position-information server. The mobile-telephone terminal 12 may acquire position information from the position information server, and send the acquired position information to the store-information server. Otherwise, the mobile-telephone terminal 12 may include a function for communicating with a UPS (Global Positioning System) satellite so as to acquire its own position information therefrom.

The system or the present invention can be realized by a general computer, without the need for a dedicated system. A program and data for controlling a computer to execute the above-described processes (procedures) may he recorded on a medium (a floppy disk, CD-ROM, DVD or the like) and distributed, and the program may be installed into the computer and run on an OS (Operating System) to execute the above-described processes, thereby achieving the system of the present invention. The above program and data may be stored in a disk device or the like in the server device on the Internet, and embedded in a carrier wave. The program aid data embedded in the carrier wave may be downloaded into the computer so as to realize the system of the present invention

The above-described embodiments arc intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention. This application is based on Japanese Patent Application No. 2000-353420 filed on Nov. 20, 2000, and including specification, claims, drawings and summary. The disclosure of the above Japanese Patent Application is incorporated herein by reference in its entirety.

What is claimed is:

1. A method of providing a mobile-telephone terminal with store-information, said method comrpising:
setting said at least one mobile-telephone terminal to display a commodity selection menu, on which a user of said mobile-telephone terminal selects a commodity from a plurality of commodities;
receiving commodity information regarding the commodity selected by t user;
searching a store-information database storing the commodity information and store summary information including a name, an address and a phone of one or more stores dealing the commodity specified in the commodity information, based on the commodity information and positional information representing a position of the mobile-telephone terminal, and determining one store located closest to the position of the mobile-telephone terminal among any other stores dealing the specified commodity;
accessing stock information representing a stock of commodities dealt by the determined store, and acquiring the stock information; and
sending the store summary information regarding the determined store which is located closest to the position of the mobile-telephone terminal and the acquired stock information to the mobile-telephone terminal, and setting the mobile-telephone terminal to display the sent information.

2. The method according to claim 1, wherein
the positional information is obtained by a mobile-telephone base station to which said mobile-telephone terminal is connected.

3. The method according to claim 1, further including:
in a case where to specify the positional information,
receiving identification information for identifying a mobile-telephone base station to which said mobile-telephone terminal is connected; and
specifying the positional information, based on the identification information.

4. The method According to claim 1, further including:
in a case where to specify the positional information,
receiving intensity information representing intensity of waves to be received from one or more neighboring mobile-telephone base stations to said mobile-telephone terminal and base-station identification information of the one or more neighboring mobile-telephone base stations; and
specifying the positional information, based on the intensity information and the base-station identification information.

5. The method according to claim 1, further including
in a case where to specify the positional information,
accessing a position-information sever, providing the positional information of the mobile telephone terminal based on intensity information representing intensity of waves to be received from one or more neighboring mobile-telephone base stations to said mobile-telephone terminal and base-station identification information of the one or more neighboring mobile-telephone base stations, thereby specifying the positional information.

6. The method according to claim 1, wherein
the positional information is obtained by said mobile-telephone terminal performing data communication with a GPS (Global Positioning System) satellite.

7. The method according to claim 1, further including
in a case where to acquire the stock information,
accessing a store terminal managing the stock information.

8. The method according to claim 1, wherein
the stock information is updated in real time by said store terminal.

9. The method according to claim 1, further including:
setting said at least one mobile-telephone terminal to display a commodity-ordering page for giving an order for the selected commodity;
receiving commodity-ordering information which said user input to give the order for the selected commodity on the commodity-ordering page;
sending the received commodity-ordering information to a store terminal managing the stock information; and
sending advance-ordering information representing an advance order for the ordered commodity to said mobile-telephone terminal, in response to a reply to the commodity-ordering information from the store terminal.

10. A method of providing a mobile-telephone terminal with store-information, said method comprising:
setting said mobile-telephone terminal to display a commodity selection menu for selecting one commodity from a plurality or commodities, on said mobile-telephone terminal;
sending commodity information regarding the commodity selected by a user of said mobile-telephone terminal on the commodity selection menu, to a store-information server connected to a mobile-telephone network;
searching a store-information database storing the commodity information and store summary information including a name, an address and a phone number or one or more store dealing the commodity specified in the commodity information, based on the commodity information and positional information representing a position or the mobile-telephone terminal, in said store-information server having received the commodity information, and determining one store located closest to the position of the mobile-telephone terminal among any other stores dealing the commodity specified in the commodity information, on said store-information server having received the commodity information;
accessing stock information representing a stock of commodities dealt by the determined store, and acquiring the stock information; and
sending the store summary information regarding the determined store which is located closest to the position of the mobile-telephone terminal and the acquired stock information to the mobile-telephone terminal, ad setting the mobile-telephone terminal to display the sent information.

11. The method according to claim 10, further including
in a case where to specify the positional information,
receiving intensity information representing intensity of waves to be received from one or more neighboring mobile-telephone base stations to said mobile-telephone terminal and base-station identification information of the one or more neighboring mobile-telephone base stations; and
specifying the positional information, based on the intensity information und the base-station identification information.

12. A store-information server coupled to a mobile-telephone network through a communication line and comprising: a processor, a storage unit; an input/output unit performing data communications with said mobile-telephone network through the communication line; a communication unit coupled to a store-terminal managing stock information of commodities dealt by each of a plurality of stores, through a network; and a store-information database storing commodity information regarding each of the commodities and store summary information including a name, an address and a phone number of each of the stores dealing the commodities specified in the commodity information,
wherein said processor
receives the commodity information regarding a commodity selected by a user of said mobile-telephone terminal, from said mobile-telephone terminal through said input/output unit,
searches said store-information database for one store located closest to a position of said mobile-telephone terminal among any other stores dealing the user-selected specified commodity, based on the commodity information regarding the user-selected commodity and positional information representing the position of said mobile-telephone terminal,
accessing a store terminal managing stock information of the determined store closest to the position of said mobile-telephone terminal, and acquiring the stock information of the selected commodity; and
sending the store summary information regarding the determined store closest to the position or said mobile-telephone terminal and the acquired stock information to said mobile-telephone terminal and setting said mobile-telephone terminal to display the sent information thereon.

13. The store-information server according to claim 12, wherein
said processor receives the positional information from a mobile-telephone base station to which said mobile-telephone terminal is connected, through said input/output unit.

14. The store-information server according to claim 12, wherein
said processor
receives identification information identifying the mobile-telephone base station to which said mobile-telephone terminal is connected, through said input/output unit and
specifies the positional information based on the received identification information.

15. The store-information server according to claim 12, wherein
said processor
receives intensity information representing intensity of waves to be received from one or more neighboring mobile-telephone base stations to said mobile-telephone terminal and base-station identification information or the one or more neighboring mobile-telephone base stations, from said mobile-telephone terminal through said input/output unit, and
specifying the positional information, based on the intensity information and the base-station identification information.

16. The store-information server according to claim 15, wherein
said processor accesses a position-information server providing the positional information based on the base-station identification information and the intensity information, so as to specify the positional information.

17. The store-information server according to claim 12, wherein
said processor receives the positional information of said mobile-telephone terminal through said input/output unit, the positional information acquired in said mobile-telephone terminal by a communication with a GPS satellite.

18. The store-information server according to claim 12, wherein
said processor
receives commodity-ordering information input by the user to make an order for the selected commodity, from said mobile-telephone terminal through said input/output unit,
sending the received commodity-ordering information to a store terminal managing the stock information or commodities dealt by the closest store, through said communications unit, and
sending advance-ordering information for giving an order i,)r the ordered commodity to said mobile-telephone terminal through the input/output unit, in response to a reply to the commodity-ordering information from the store terminal.

19. The store-information server according to claim 12, wherein
said store-information database is connected to said communications unit through the network.

20. A program for controlling a computer to execute:
setting a mobile-telephone terminal to display a commodity selection menu for selecting a commodity from a plurality of commodities;
receiving commodity information regarding the commodity selected by a user of said mobile-telephone terminal on said commodity selection menu;
searching a store-information database storing the commodity information and store summary information including a name, an address and a phone number of a store dealing the commodity specified in the commodity information, based on the commodity information and positional information representing a position of the mobile-telephone terminal, and determining one store located closest to the position of the mobile-telephone terminal among any other stores dealing the commodity specified in the commodity information
accessing stock information representing a stock of commodities dealt by the determined closest store, and acquiring the stock information; and
sending the store summary information regarding the determined store which is located closest to the position or of mobile-telephone terminal and the acquired stock information to the mobile-telephone terminal and setting the mobile-telephone terminal to display the sent information.
